(19) United States
(12) Patent Application Publication
(10) Pub. No.: US 2014/0098223 A1
(43) Pub. Date: Apr. 10, 2014

(54) SIZE MEASUREMENT APPARATUS AND SIZE MEASUREMENT METHOD

(71) Applicant: OPTEX Co., Ltd., Shiga (JP)

(72) Inventors: Norikazu MURATA, Shiga (JP); Takuji KAWAKUBO, Shiga (JP)

(73) Assignee: OPTEX Co., Ltd., Shiga (JP)

(21) Appl. No.: 14/048,132

(22) Filed: Oct. 8, 2013

(30) Foreign Application Priority Data
Oct. 9, 2012 (JP) 2012-224437

(51) Int. Cl. G01B 11/02

(52) U.S. Cl. CPC G01B 11/022
USPC 348/135

(57) ABSTRACT

A size measurement apparatus includes: a first light emitter unit for widely emitting light to an imaging area which may include an object; a second light emitter unit for locally emitting light to a part of the imaging area; an image taking unit for obtaining a range image which contains distance information on a pixel-by-pixel basis, with pixels being arranged two-dimensionally, the distance information being calculated based on a measured time value which is a time for the light emitted from the light emitter units to travel back as a reflected light; and an arithmetic control unit for controlling light emission from the light emitter units, and for calculating size information of the object based on a synthesized range image obtained by synthesizing a range image obtained during light emission from the first light emitter unit and a range image obtained during light emission from the second light emitter unit.

### CROSS-REFERENCE TO RELATED APPLICATION AND CLAIM FOR PRIORITY

The present application claims priority under 35 U.S.C. §119(a) to Japanese Patent Application No. 2012-224437, filed Oct. 9, 2012. The contents of this application are incorporated herein by reference by their entirety.

### BACKGROUND OF THE INVENTION

1. Field of the Invention

The present invention relates to size measurement apparatuses and size measurement methods. In particular, regarding the size measurement using a TOF range imaging camera, the present invention relates to a size measurement apparatus and a size measurement method with improved distance measurement precision, by keeping measurement errors to a minimum or at a fixed level, irrespective of distance, and thereby facilitating correction of measurement errors.

2. Related Technology

Conventionally, in order to control physical distribution equipment such as a belt conveyor, JP 2000-171215A, for example, suggests a physical distribution information reader which takes an image of an object transported in a path and processes the image to obtain information about the size and orientation of the object and the distance between objects.

Further, JP 2004-102979 A, for example, suggests a three-dimensional shape display device which can easily measure an approximate size of a three-dimensional object. JP 2006-153771 A, for example, suggests a measurement apparatus which can estimate the shape of an object by extracting edges of the object based on at least either of its grayscale image or range image, and which can obtain an actual size between specific parts corresponding to two measured points based on corresponding three-dimensional positions of the measured points in the range image.

Further, in order to solve problems involved in precise size measurement of a cardboard box or the like by these conventional techniques, JP 2011-196860 A, for example, suggests an object size measurement method and an object size measurement apparatus which only require installation of a range imaging camera without any special installation jigs or the like and which can achieve a size measurement precision better than the resolution of the range imaging camera.

The conventional TOF range imaging camera, as disclosed by JP 2011-196860 A mentioned above or by other prior art, distributes light over the entire screen by a light emitting unit, and obtains a distance value of each section of the screen on a pixel-by-pixel basis. Distance values are located on the XYZ orthogonal coordinate system to produce a stereoscopic range image.

However, due to the mechanism that distributes light over the entire screen and receives light by a wide-angle lens, the conventional TOF range imaging camera is influenced by multiple reflection, irregular reflection or the like caused by an object to be measured, environments, and structural components in the camera. Hence, the distance value of the position of the object, which is calculated by ray optics, is affected by ambient reflectance and distance.

For example, in the case where an object has a plate-like shape and is oriented vertically to the optical axis of a received light, the light reflected by peripheral parts of the plate is incident on receiving pixels at the center of the screen, causing a distance value at the center of the screen to be greater (farther) than in reality.

This phenomenon is emphasized at a closer range. Even in the same plate-like object having a fixed reflectance, measured distance values (and hence differences between the actual distances and the measured distances) vary depending on the distance from the camera. The error in the distance value is greater at a closer range.

Stereoscopic shape recognition in the entire screen is carried out by calculation based on the distance value for each pixel data. Hence, if the degree of errors in measured distances is not fixed due to various parameters such as screen position, ambient reflectance and measured distance, correction of errors is impossible. In the orthogonal coordinate system, the X and Y values are calculated from an exact Z value. If a Z value includes a measurement error, X and Y values will have greater errors.

As a specific example, these technologies are applied to measure the size of a cardboard box or the like, for example, at a counter of parcel delivery service. Currently, the delivery charge is determined by a manually measured parcel size (length, width and height). If an untrained person measures the parcel size in a short time in haste, a measured size may be considerably different from an actual size. If the measured size is smaller than in reality and the parcel is undercharged, the sales and profits of the shop may be adversely affected.

### SUMMARY OF THE INVENTION

Regarding the size measurement using a TOF range imaging camera, the present invention provides a size measurement apparatus and a size measurement method with improved distance measurement precision, by keeping measurement errors to a minimum or at a fixed tendency, irrespective of distance, and thereby facilitating correction of measurement errors.

According to a first aspect of the present invention, a size measurement apparatus includes a first light emitter unit, a second light emitter unit, an image taking unit, and an arithmetic control unit. The first light emitter unit widely emits light to an imaging area which may include an object. The second light emitter unit locally emits light to a part of the imaging area. The image taking unit obtains a range image which contains distance information on a pixel-by-pixel basis, with pixels being arranged two-dimensionally. The distance information is calculated based on a measured time value which is a time for the light emitted from the first light emitter unit or the second light emitter unit to travel back as a reflected light. The arithmetic control unit controls light emission from the first light emitter unit and the second light emitter unit, and calculates size information of the object based on a synthesized range image obtained by synthesizing a range image obtained during light emission from the first light emitter unit and a range image obtained during light emission from the second light emitter unit.

In this size measurement apparatus, the first light emitter unit and the second light emitter unit may be, but not limited to, for example, light emitting diodes or semiconductor lasers which emit infrared light. The image taking unit may be, for example, a so-called TOF (time-of-flight) range image sensor. The arithmetic control unit may be, but not limited to, for example, a CPU.

The size measurement apparatus of this configuration can improve distance measurement precision by keeping measurement errors to a minimum or at a fixed level, irrespective of distance, and thereby facilitating correction of measurement errors.

In the size measurement apparatus according to the first aspect of the present invention, the second light emitter unit may emit light to a substantially central part in the imaging area.

In the size measurement apparatus according to the first aspect of the present invention, the second light emitter unit may be configured to be capable of selectively emitting light to different parts in the imaging area, and the arithmetic control unit may obtain the synthesized range image by synthesizing the range image obtained during light emission from the first light emitter unit and respective range images obtained during selective light emission from the second light emitter unit. In this case, the second light emitter unit may have a plurality of light emitters which emit light to different parts in the imaging area.

According to a second aspect of the present invention, a size measurement apparatus includes a light emitter unit, an image taking unit, and an arithmetic control unit. The light emitter unit selectively emits light to different parts in an imaging area which may include an object. The image taking unit obtains a range image which contains distance information on a pixel-by-pixel basis, with pixels being arranged two-dimensionally. The distance information is calculated based on a measured time value which is a time for the light emitted from the light emitter unit to travel back as a reflected light. The arithmetic control unit controls selective light emission from the light emitter unit, and calculates size information of the object based on a synthesized range image obtained by synthesizing respective range images obtained during selective light emission from the light emitter unit.

In the size measurement apparatus according to the second aspect of the present invention, the light emitter unit may have a plurality of light emitters which emit light to different parts in the imaging area.

In the size measurement apparatus according to the second aspect of the present invention, the light emitter unit may include a light emitter for locally emitting light to a part of the imaging area, and a scanning mechanism which can change an emission direction of the light from the light emitter within the imaging area. Preferably, the light emitted from this light emitter is a laser beam.

According to a third aspect of the present invention, a size measurement apparatus includes a light emitter unit, a scanning mechanism, an image taking unit, and an arithmetic control unit. The light emitter unit emits a laser beam to an imaging area which may include an object. The scanning mechanism is capable of changing an emission direction of the laser beam from the light emitter unit within the imaging area. The image taking unit obtains a range image which contains distance information on a pixel-by-pixel basis, with pixels being arranged two-dimensionally. The distance information is calculated based on a measured time value which is a time for the laser beam emitted from the light emitter unit to travel back as a reflected light. The arithmetic control unit controls the scanning mechanism and the laser beam emission from the light emitter unit, and calculates size information of the object based on the range image. The scanning mechanism scans an entirety of the imaging area with the laser beam emitted from the light emitter unit while the image taking unit obtains a frame of the range image.

In the size measurement apparatus according to the third aspect of the present invention, the scanning mechanism may be controlled in such a manner that only the position of an object is scanned with a laser beam. In this case, however, the scanning mechanism is required to emit a laser beam widely over the entire screen in advance, so as to identify the position of the object. By limiting the scanning range, it is possible to reduce the scanning time and the measurement time, and to cut the emission energy.

According to a fourth aspect of the present invention, a size measurement method using a TOF range imaging camera includes a first light emitting step, a second light emitting step, an image taking step, and an arithmetic step. The first light emitting step is for widely emitting light to an imaging area which may include an object. The second light emitting step is for locally emitting light to a part of the imaging area. The image taking step is for obtaining a range image which contains distance information on a pixel-by-pixel basis, with pixels being arranged two-dimensionally. The distance information is calculated based on a measured time value which is a time for the light emitted in the first light emitting step or the second light emitting step to travel back as a reflected light. The arithmetic step is for calculating size information of the object based on a synthesized range image obtained by synthesizing a range image obtained during light emission in the first light emitting step and a range image obtained during light emission in the second light emitting step.

The size measurement method of this configuration can improve distance measurement precision by keeping measurement errors to a minimum or at a fixed level, irrespective of distance, and thereby facilitating correction of measurement errors.

### BRIEF DESCRIPTION OF THE DRAWINGS

FIG. 1 is a block diagram showing a schematic configuration of a range imaging camera 10 according to First Embodiment of the present invention.

FIG. 2 is a schematic illustration for describing a positional relationship in the case where the range imaging camera 10 takes an image of a cardboard box 20 from substantially right above.

FIG. 3(a) is a side view showing a positional relationship of the cardboard box 20 and the emission range of infrared light L11 emitted from a wide light emitter unit 11 of the range imaging camera 10, and FIG. 3(b) is a plan view thereof. FIG. 3(c) is a side view showing a positional relationship of the cardboard box 20 and the emission range of infrared light L12 emitted from a local light emitter unit 12, and FIG. 3(d) is a plan view thereof.

FIG. 4 is a graph showing an example of the distance precision improvement effect, regarding a range image G12 obtained during infrared light emission from the local light emitter unit 12.

FIG. 5 is a flowchart which outlines an arithmetic processing by an arithmetic control unit 14 of the range imaging camera 10.

FIG. 6 is a block diagram showing a schematic configuration of a range imaging camera 10A according to Second Embodiment of the present invention.

FIG. 7(a) to FIG. 7(d) are plan views showing positional relationships of the cardboard box 20 and the emission ranges of infrared light L12a to L12d emitted from the local light emitter unit 12A of the range imaging camera 10A.

FIG. 8 is a block diagram showing a schematic configuration of a range imaging camera 10B according to Third Embodiment of the present invention.

FIG. 9 is a plan view showing the emission range of an infrared laser beam L12B from a laser unit 12B of the range imaging camera 10B as well as the scanning path in the imaging area A13.

### DESCRIPTION OF THE PREFERRED EMBODIMENTS

Hereinafter, embodiments of the present invention are described with reference to the drawings.

### First Embodiment

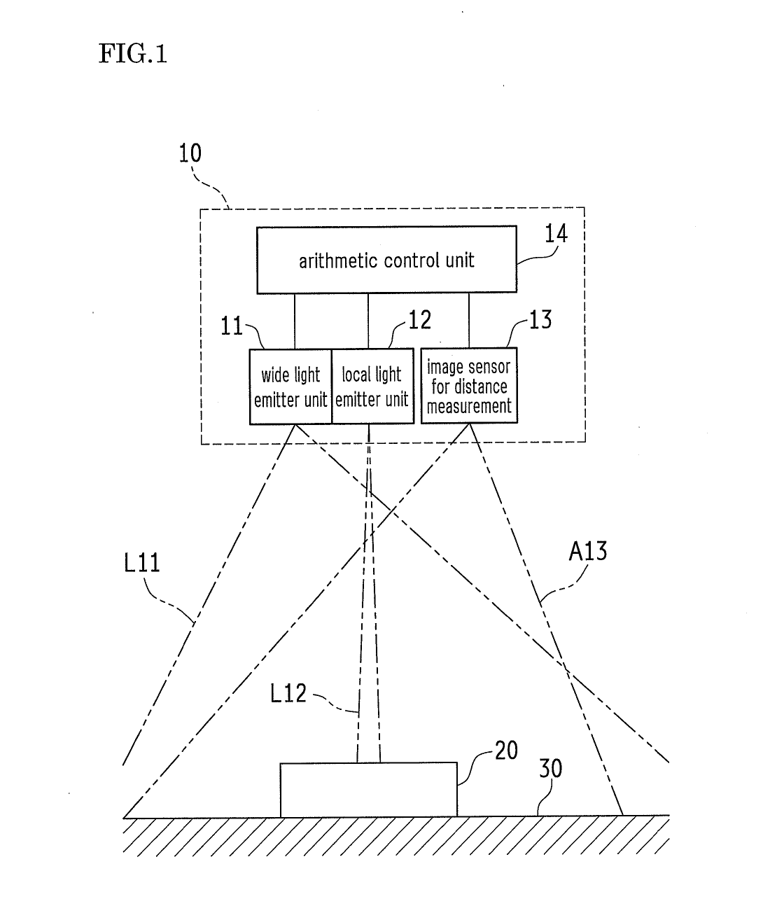

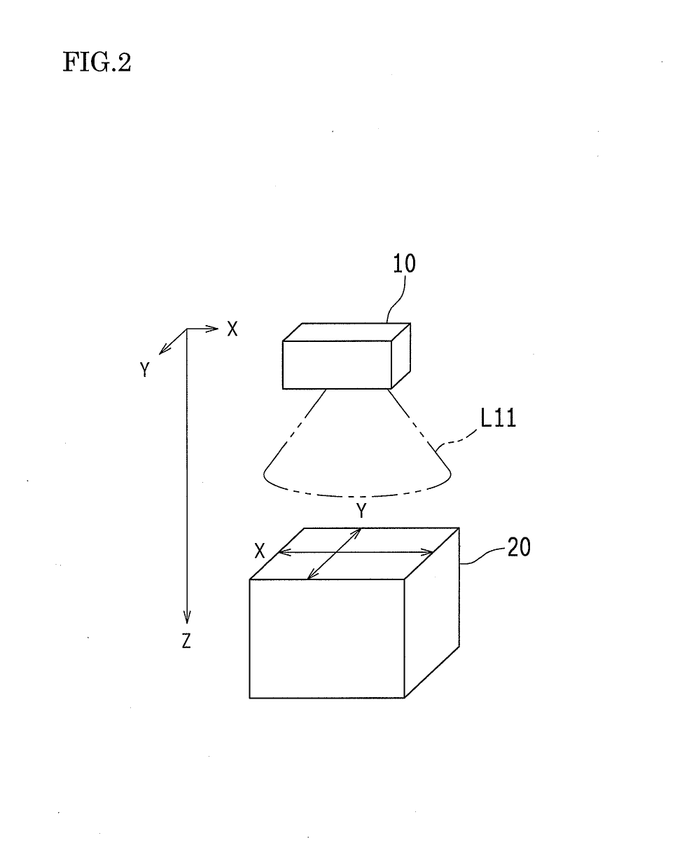

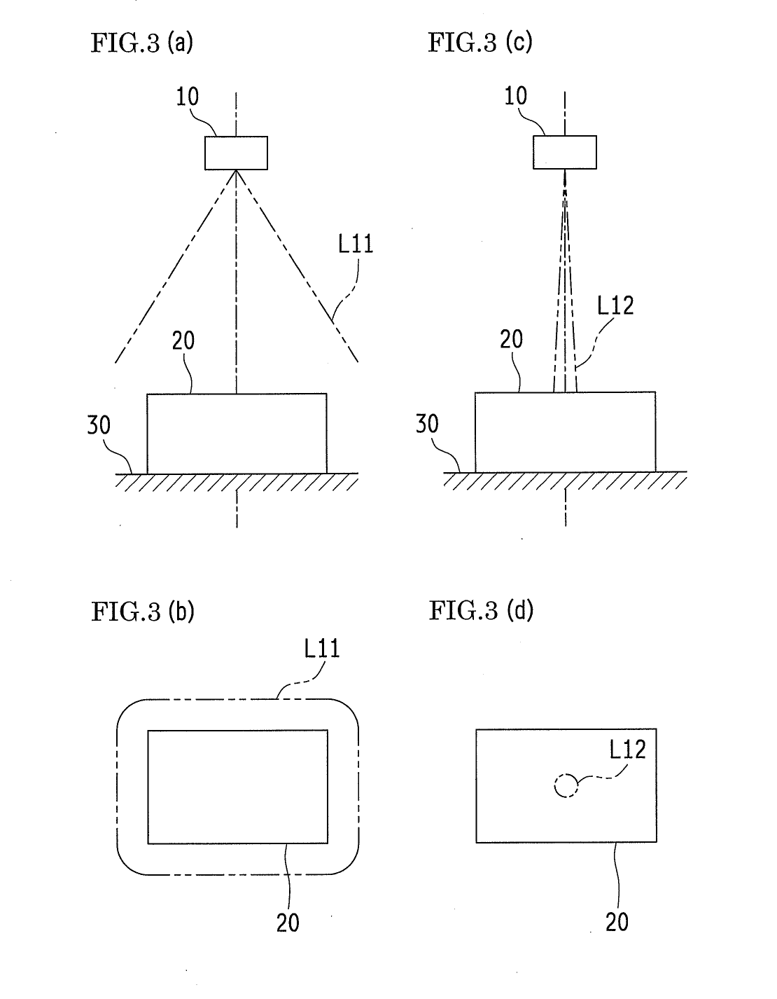

FIG. 1 is a block diagram showing a schematic configuration of a range imaging camera 10 according to First Embodiment of the present invention. FIG. 2 is a schematic illustration for describing a positional relationship in the case where the range imaging camera 10 takes an image of a cardboard box 20 from substantially right above. FIG. 3(a) is a side view showing a positional relationship of the cardboard box 20 and the emission range of infrared light L11 emitted from a wide light emitter unit 11 of the range imaging camera 10, and FIG. 3(b) is a plan view thereof. FIG. 3(c) is a side view showing a positional relationship of the cardboard box 20 and the emission range of infrared light L12 emitted from a local light emitter unit 12, and FIG. 3(d) is a plan view thereof.

The range imaging camera 10 also operates as an apparatus for measuring the size of an object. For example, the range imaging camera 10 is suitable for automatically measuring the size of a cuboidal object such as a cardboard box 20 at a counter of parcel delivery service.

As shown in FIG. 1, the range imaging camera 10 is equipped with a wide light emitter unit 11, a local light emitter unit 12, an image sensor 13 for distance measurement, and an arithmetic control unit 14 (for example, a CPU). The wide light emitter unit 11 emits infrared light L11 substantially uniformly to the entirety of an imaging area A13 which includes an object (e.g. a cardboard box 20) set on a placement surface 30. The local light emitter unit 12 locally emits infrared light L12 to a part (for example, the center) of the imaging area A13. The image sensor 13 for distance measurement can obtain a range image which contains distance data on a pixel-by-pixel basis, with pixels being two-dimensionally arranged in a grid pattern. The distance data is calculated based on a measured time value which is a time for the infrared light L11 or L12 emitted from the wide light emitter unit 11 or the local light emitter unit 12 to be reflected and travel back. The arithmetic control unit 14 controls infrared light emission from the wide light emitter unit 11 and the local light emitter unit 12 (in terms of emission intensity, emission time, emission timing, etc.). The arithmetic control unit 14 further calculates size data of the object based on a synthesized range image Gm obtained by synthesizing a range image G11 obtained during infrared light emission from the wide light emitter unit 11 and a range image G12 obtained during infrared light emission from the local light emitter unit 12.

In this context, “synthesis” of range images means not only simple pixel-by-pixel addition and averaging of a plurality of range images, but also, for example, correction of pixel values of other range images based on pixel values of all or a part of pixels in a specific range image.

The wide light emitter unit 11 and the local light emitter unit 12 may be, but not limited to, for example, light emitting diodes or semiconductor lasers which emit infrared light.

The image sensor 13 for distance measurement may be, for example, a so-called TOF (time-of-flight) range image sensor.

In FIG. 1, the range imaging camera 10 is illustrated on an unproportionally enlarged scale relative to the cardboard box 20, in order to describe the configuration of the range imaging camera 10 and for other illustrative purpose. Therefore, the optical axes of the wide light emitter unit 11, the local light emitter unit 12 and the image sensor 13 for distance measurement look quite apart from each other, but in fact these optical axes are close enough to each other. For example, FIG. 3(a) to FIG. 3(d) to be mentioned later illustrate truer positional relationships of the range imaging camera 10, the infrared light L11 emitted from the wide light emitter unit 11, the infrared light L12 emitted from the local light emitter unit 12, and the cardboard box 20.

To measure the size of a cuboidal object such as the cardboard box 20, the range imaging camera 10 is installed in a positional relationship as shown in FIG. 2, so as to take an image of the cardboard box 20 from substantially right above and to allow the wide light emitter unit 11 to emit infrared light L11 substantially uniformly over the imaging area including the cardboard box 20.

More specifically, the range imaging camera 10 is located such that the infrared light L11 emitted from the wide light emitter unit 11 and the cardboard box 20 are in a positional relationship as shown, for example, in FIG. 3(a). FIG. 3(b) shows this positional relationship in plan view, wherein the infrared light L11 emitted from the wide light emitter unit 11 irradiates the imaging area A13 including the cardboard box 20 in a substantially uniform manner (see also FIG. 1).

On the other hand, the infrared light L12 emitted from the local light emitter unit 12 is localized substantially to the center of the top surface of the cardboard box 20 as shown, for example, in FIG. 3(c) and FIG. 3(d).

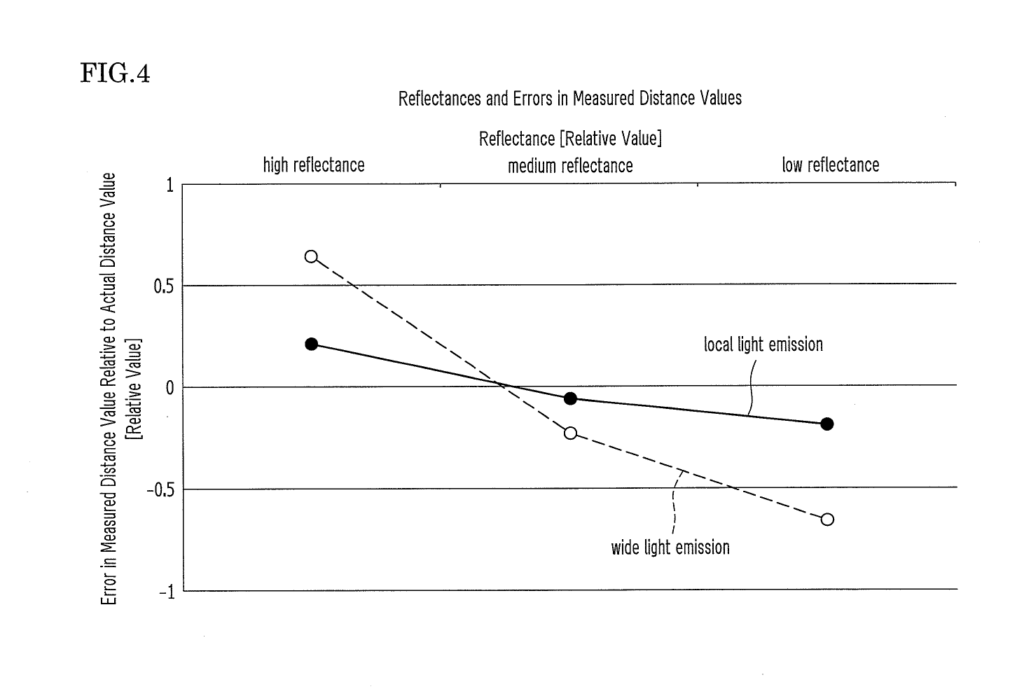

As shown in FIG. 4, the distance accuracy in the range image G12 obtained during infrared light emission from the local light emitter unit 12 is much better than the distance accuracy in the range image G11 obtained during infrared light emission from the wide light emitter unit 11. In particular, errors due to ambient reflectance are considerably fewer.

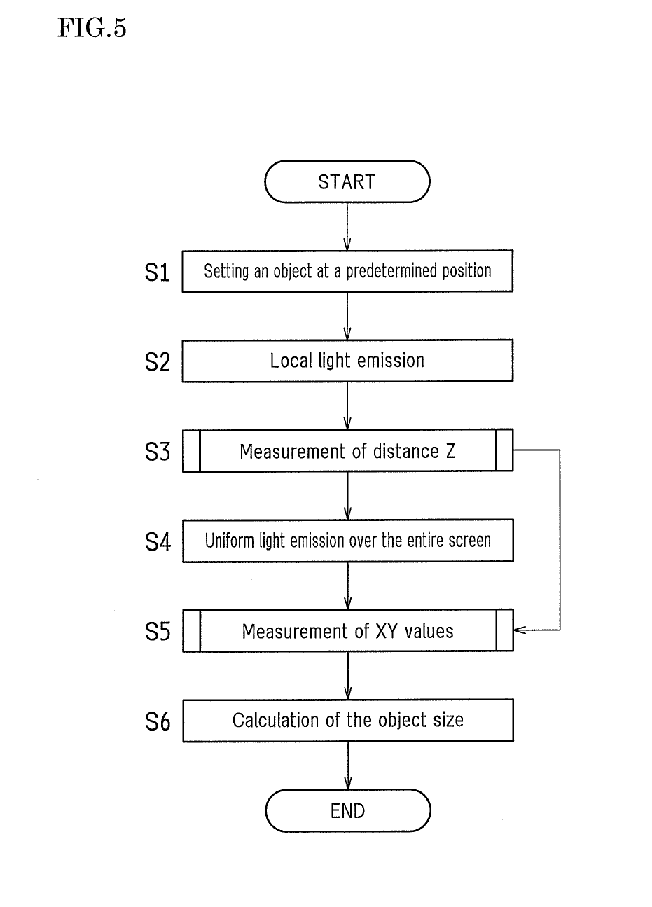

FIG. 5 is a flowchart which outlines an arithmetic processing by the arithmetic control unit 14 of the range imaging camera 10, assuming, by way of example, that the size of a cuboidal object such as a cardboard box 20 is automatically measured at a counter of parcel delivery service.

Prior to the measurement, the range imaging camera 10 is installed vertically, facing downward (see FIG. 2 and FIG. 3(a) to FIG. 3(d)). As described in FIG. 5, an object to be measured (e.g. a cardboard box 20) is set at a predetermined position on a placement surface 30, right below the range imaging camera 10 (Step S1), while making sure that the object is located substantially at the center of the imaging area A13 of the range imaging camera 10. This positioning also ensures that infrared light L12 from the local light emitter unit 12 is emitted substantially to the center of the top surface of the cardboard box 20.

Next, the local light emitter unit 12 locally emits infrared light L12 to the center of the imaging area A13, and the image sensor 13 for distance measurement obtains a range image G12 (Step S2).

A distance value (Z value) at the center of the screen is calculated from the thus obtained range image G12 (Step S3). In this context, a distance value may be obtained not only from one pixel but also from a certain mass of pixels (for example, 5×5=25 pixels). Simultaneously, it is also possible to carry out time averaging and/or pixel averaging of continuous 100 frames. Additionally, it is preferable to perform elimination of noises, exclusion of abnormal values in averaging, or other processes.

Then, the wide light emitter unit 11 emits infrared light L11 substantially uniformly to the entire imaging area A13, and the image sensor 13 for distance measurement obtains a range image G11 (Step S4).

As discussed above in the section of RELATED TECHNOLOGY, the distance value (Z value) for each pixel calculated from the range image G11 is not necessarily satisfactory in terms of distance accuracy. Therefore, an error is calculated by a comparison between the distance value (Z value) for each pixel calculated from the range image G11 and the distance value (Z value) at the center of the screen calculated in Step S3 from the range image G12, and correction is effected to eliminate the error. Specifically, the length and width of the cardboard box 20 are measured by extracting a top surface edge at the left, right, top and bottom in the screen from the distance value (Z value) of the top surface of the cardboard box 20 (Step S5). Since X and Y values are corrected based on the exact distance value (Z value) of the top surface, the XY accuracy can be also improved.

Finally, the distance value (Z value) of the top surface of the cardboard box 20 is subtracted from the distance value (Z value) of the placement surface 30 on which the cardboard box 20 is set. The difference is regarded as the height of the cardboard box 20, and thus the size of the object such as the cardboard box 20 is calculated (Step S6).

For calculation of the size of the object, the technology disclosed in, for example, JP 2011-196860 A mentioned above may be applied.

According to the above-described configuration of First Embodiment, it is possible to obtain the size (i.e. length, width and height) of a cardboard box 20 or other object with high accuracy, by automatically switching between the wide light emitter unit 11 which emits infrared light L11 substantially uniformly to the entire imaging area A13 and the local light emitter unit 12 which locally emits infrared light L12 to the center of the imaging area A13, and by automatically correcting the distance value of the range image G11 obtained during infrared light emission from the wide light emitter unit 11, based on the distance value of the range image G12 obtained during infrared light emission from the local light emitter unit 12.

If this range imaging camera 10 is utilized to measure the size of a cardboard box or other object at a counter of parcel delivery service or the like, it is possible to achieve quick and exact size measurement irrespective of the skill of a staff member, and thus is possible to charge a right rate without fail and to avoid disadvantageous effects on sales and profits at a shop.

### Second Embodiment

Taking a physical distribution working site as an example, cuboidal or irregular-shaped parcels are carried on a belt conveyor and loaded all together in a cargo container for shipping. In the situation where the range imaging camera 10 of First Embodiment is installed above the belt conveyor in a vertical downward-facing manner, however, the parcels carried on the belt conveyor do not necessarily pass through the center of the screen of the range imaging camera 10. Further, if a parcel is not cuboidal but has a an irregular shape, distance values of various sections are regarded as corresponding to a top surface of the parcel, and the top surface cannot be approximated in one plane.

Second Embodiment is described below in view of these facts. Namely, the wide light emitter unit 11 is removed from the range imaging camera 10 of First Embodiment, and the local light emitter unit 12 is modified to emit infrared light locally to a plurality of positions in the screen.

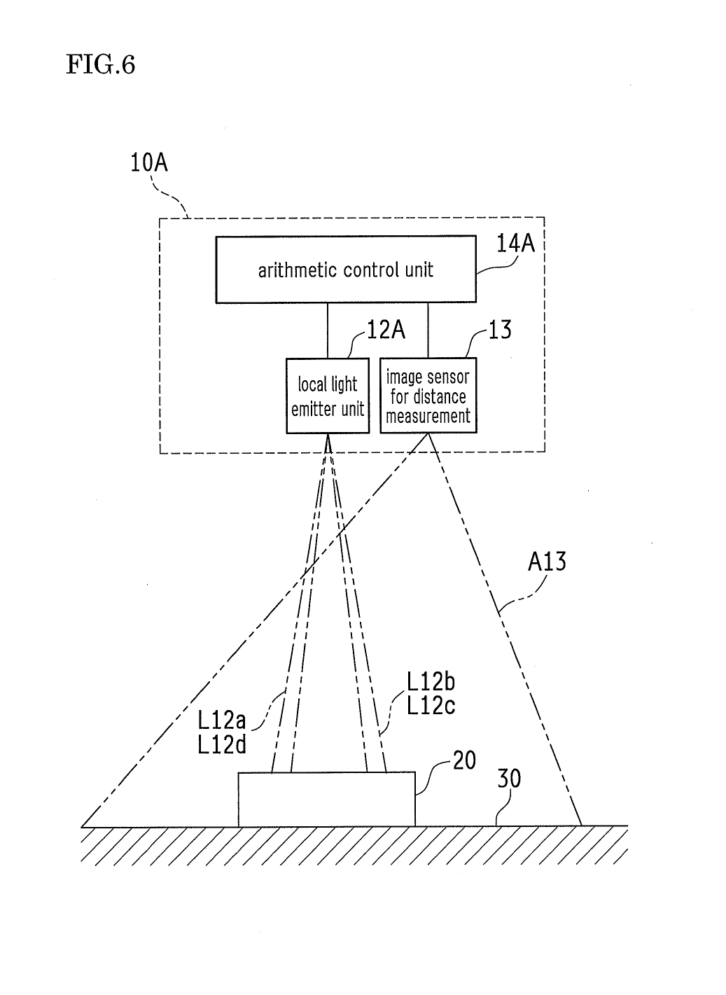

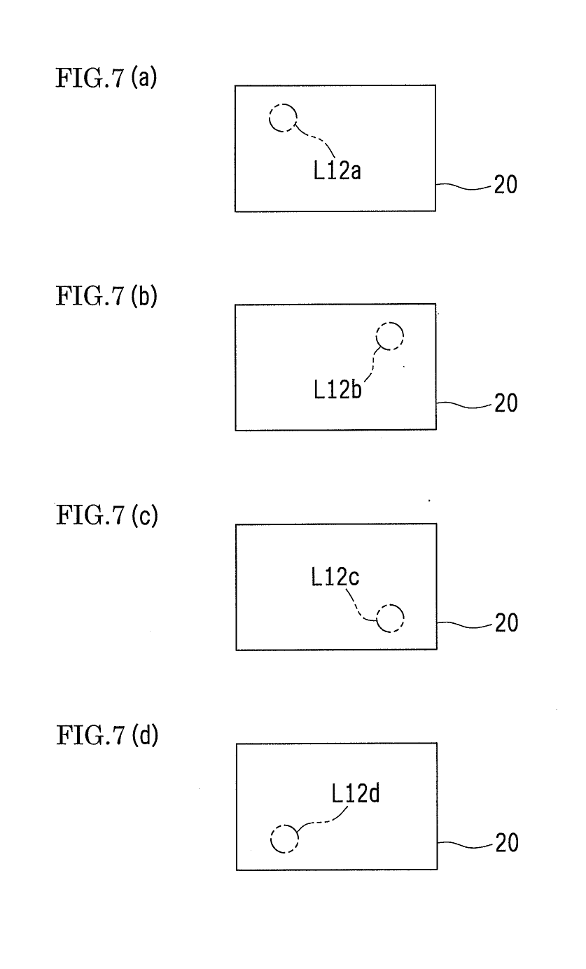

FIG. 6 is a block diagram showing a schematic configuration of a range imaging camera 10A according to Second Embodiment of the present invention. FIG. 7(a) to FIG. 7(d) are plan views showing positional relationships of the cardboard box 20 and the emission ranges of infrared light L12a to L12d emitted from the local light emitter unit 12A of the range imaging camera 10A. The same elements as mentioned in First Embodiment are designated with the same reference signs, and the following description is concentrated on differences from First Embodiment.

As shown in FIG. 6, the range imaging camera 10A is equipped with a local light emitter unit 12A, an image sensor 13 for distance measurement, and an arithmetic control unit 14A. The local light emitter unit 12A has four light emitters which emit infrared light L12a-L12d to four different positions within the imaging area A13 including an object (e.g. a cardboard box 20) set on a placement surface 30. The image sensor 13 for distance measurement can obtain a range image which contains distance data on a pixel-by-pixel basis, with pixels being two-dimensionally arranged in a grid pattern. The distance data is calculated based on measured time values which are times for the infrared light L12a-L12d emitted from the local light emitter unit 12A to be reflected and travel back. The arithmetic control unit 14A controls infrared light emission from each of the light emitters of the local light emitter unit 12A. The arithmetic control unit 14A further calculates size data of the object based on a synthesized range image GmA obtained by synthesizing range images G12Aa-G12Ad obtained during infrared light emission from the four light emitters, respectively.

Similar to the local light emitter unit 12 in First Embodiment, the light emitters of the local light emitter unit 12A may be, but not limited to, for example, light emitting diodes or semiconductor lasers which emit infrared light. The number of the light emitters is optional and is not limited to four. The emission range of the infrared light L12a-L12d emitted from these light emitters may for example be, but not limited to, around the four corners at the top surface of the cardboard box 20 as shown in FIG. 7(a) to FIG. 7(d). Optionally, for example, a fifth light emitter may be provided to emit infrared light to the center of the top surface of the cardboard box 20.

According to the configuration of Second Embodiment as described above, even if an object to be measured (i.e. a parcel) is off-centered in a range image taken by the range imaging camera 10A, the object may be irradiated with infrared light from any of the light emitters of the local light emitter unit 12A. Eventually, it is possible to obtain a distance value (Z value) for each section with high accuracy.

### Modified Example of Second Embodiment

According to Second Embodiment, a plurality of light emitters of the local light emitter unit 12A emit infrared light to different parts in the imaging area A13. Nevertheless, depending on the position of a parcel (i.e. an object to be measured), it is still probable that the parcel is not irradiated with infrared light from any of the light emitters. Further, even if the parcel is irradiated with infrared light from one or more of the light emitters, the arithmetic control unit 14A cannot identify the specific light emitter(s) by which the parcel is irradiated with infrared light.

Hence, the range imaging camera 10A of Second Embodiment may be also equipped with a wide light emitter unit 11 that is provided in the range imaging camera 10 of First Embodiment. Further, in order to recognize the position of the parcel based on a range image G11 obtained during infrared light emission from the wide light emitter unit 11, the range image G11 may be utilized, as required, for synthesis of range images or correction of distance values in subsequent steps.

As an additional modification, the local light emitter unit 12A may have only one light emitter, in combination with a scanning mechanism that can change the emission direction of infrared light from this single light emitter within the imaging area A13. With this combination, infrared light may be emitted from the single light emitter of the local light emitter unit 12A in accordance with the parcel position recognized by the range image G11 obtained during infrared light emission from the wide light emitter unit 11.

Owing to these modifications, a distance value (Z value) is obtainable with further accuracy.

### Third Embodiment

In one of the modified examples of Second Embodiment, the single light emitter of the local light emitter unit 12A is combined with a scanning mechanism. Instead, the local light emitter unit 12A may be replaced with an infrared laser beam emission unit. If the entire imaging area A13 is constantly scanned by the infrared laser beam, the wide light emitter unit 11 for recognizing the parcel position may be omitted. This configuration is described below as Third Embodiment.

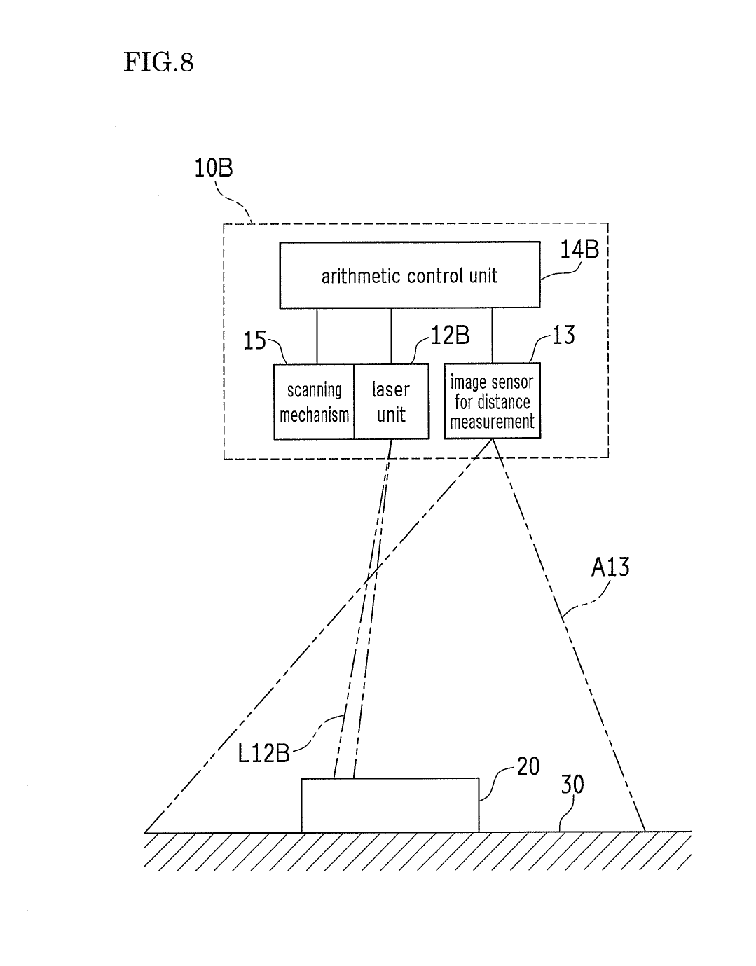

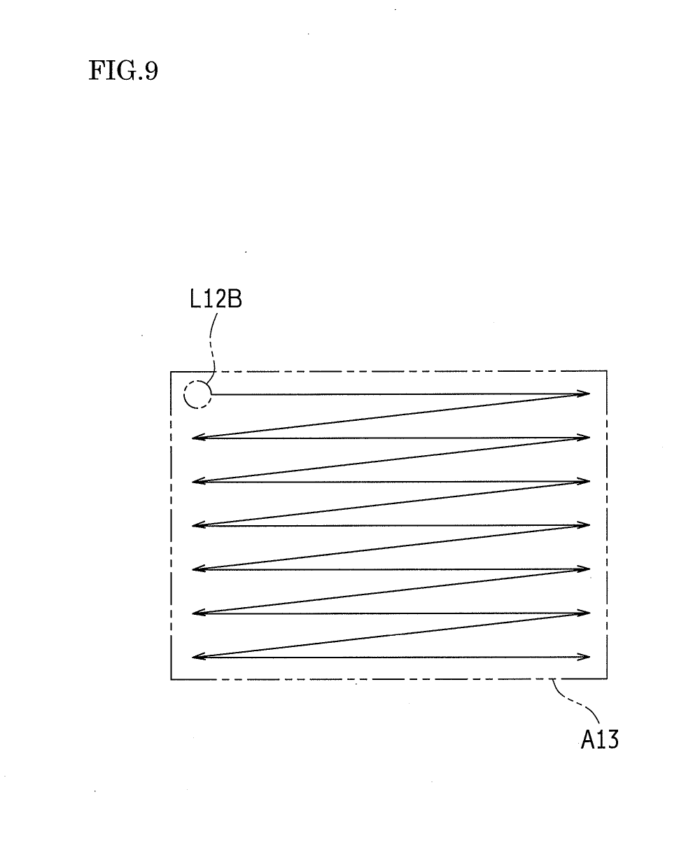

FIG. 8 is a block diagram showing a schematic configuration of a range imaging camera 10B according to Third Embodiment of the present invention. FIG. 9 is a plan view showing the emission range of an infrared laser beam L12B from a laser unit 12B of the range imaging camera 10B as well as the scanning path in the imaging area A13. The same elements as mentioned in First and Second Embodiments are designated with the same reference signs, and the following description is concentrated on differences from First Embodiment, Second Embodiment, and modified examples thereof.

As shown in FIG. 8, the range imaging camera 10B is equipped with a laser unit 12B, a scanning mechanism 15, an image sensor 13 for distance measurement, and an arithmetic control unit 14B. The laser unit 12B emits an infrared laser beam L12B to an imaging area A13 including an object (e.g. a cardboard box 20) set on a placement surface 30. The scanning mechanism 15 can change the emission direction of the infrared laser beam L12B from the laser unit 12B within the imaging area A13. The image sensor 13 for distance measurement can obtain a range image G12B which contains distance data on a pixel-by-pixel basis, with pixels being arranged two-dimensionally in a grid pattern. The distance data is calculated based on a measured time value which is a time for the infrared laser beam L12B emitted from the laser unit 12B to be reflected and travel back. The arithmetic control unit 14B controls the scanning mechanism 15 and infrared laser beam emission from the laser unit 12B. The arithmetic control unit 14 further calculates size data of the object based on the range image G12B.

In this embodiment, while the image sensor 13 for distance measurement obtains a frame of a range image G12B, the scanning mechanism 15 scans the entire imaging area A13 with the infrared laser beam L12B emitted from the laser unit 12B.

Incidentally, a laser scanning sensor with an extremely high distance accuracy requires a high light sensitivity in order to maintain its distance accuracy, and hence requires a relatively large mirror and a large light-receiving lens. Since such a sensor has a large size as a whole and has an increased inertia weight, improvement of the scanning speed has been quite difficult.

According to the configuration of Third Embodiment as described above, scanning can be performed only by means of the laser unit 12B, without requiring a large light-receiving lens or the like. Hence, the scanning mechanism can be downsized, can have a reduced inertia weight, and can enhance the scanning speed. Since the photographing time (shutter time) can be reduced, it is further possible to increase the belt conveyor speed and to enhance the efficiency of physical distribution.

The present invention may be embodied in other specific forms without departing from the spirit or essential characteristics thereof. The above-described embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A size measurement apparatus comprising:
a first light emitter unit for widely emitting light to an imaging area which may include an object;
a second light emitter unit for locally emitting light to a part of the imaging area;
an image taking unit for obtaining a range image which contains distance information on a pixel-by-pixel basis, with pixels being arranged two-dimensionally, the distance information being calculated based on a measured time value which is a time for the light emitted from the first light emitter unit or the second light emitter unit to travel back as a reflected light; and
an arithmetic control unit for controlling light emission from the first light emitter unit and the second light emitter unit, and for calculating size information of the object based on a synthesized range image obtained by synthesizing a range image obtained during light emission from the first light emitter unit and a range image obtained during light emission from the second light emitter unit.

2. The size measurement apparatus according to claim 1,
wherein the second light emitter unit emits light to a substantially central part in the imaging area.

3. The size measurement apparatus according to claim 1,
wherein the second light emitter unit is configured to be capable of selectively emitting light to different parts in the imaging area, and
the arithmetic control unit obtains the synthesized range image by synthesizing the range image obtained during light emission from the first light emitter unit and respective range images obtained during selective light emission from the second light emitter unit.

4. The size measurement apparatus according to claim 3,
wherein the second light emitter unit has a plurality of light emitters which emit light to different parts in the imaging area.

5. A size measurement apparatus comprising:
a light emitter unit for selectively emitting light to different parts in an imaging area which may include an object;
an image taking unit for obtaining a range image which contains distance information on a pixel-by-pixel basis, with pixels being arranged two-dimensionally, the distance information being calculated based on a measured time value which is a time for the light emitted from the light emitter unit to travel back as a reflected light; and
an arithmetic control unit for controlling selective light emission from the light emitter unit, and for calculating size information of the object based on a synthesized range image obtained by synthesizing respective range images obtained during selective light emission from the light emitter unit.

6. The size measurement apparatus according to claim 5,
wherein the light emitter unit has a plurality of light emitters which emit light to different parts in the imaging area.

7. The size measurement apparatus according to claim 5,
wherein the light emitter unit includes:
a light emitter for locally emitting light to a part of the imaging area; and
a scanning mechanism which can change an emission direction of the light from the light emitter within the imaging area.

8. The size measurement apparatus according to claim 7,
wherein the light emitted from the light emitter is a laser beam.

9. A size measurement apparatus comprising:
a light emitter unit for emitting a laser beam to an imaging area which may include an object;
a scanning mechanism being capable of changing an emission direction of the laser beam from the light emitter unit within the imaging area;
an image taking unit for obtaining a range image which contains distance information on a pixel-by-pixel basis, with pixels being arranged two-dimensionally, the distance information being calculated based on a measured time value which is a time for the laser beam emitted from the light emitter unit to travel back as a reflected light; and
an arithmetic control unit for controlling the scanning mechanism and the laser beam emission from the light emitter unit, and for calculating size information of the object based on the range image,
wherein the scanning mechanism scans an entirety of the imaging area with the laser beam emitted from the light emitter unit while the image taking unit obtains a frame of the range image.

10. A size measurement method using a TOF range imaging camera, comprising:
a first light emitting step for widely emitting light to an imaging area which may include an object;
a second light emitting step for locally emitting light to a part of the imaging area;
an image taking step for obtaining a range image which contains distance information on a pixel-by-pixel basis, with pixels being arranged two-dimensionally, the distance information being calculated based on a measured time value which is a time for the light emitted in the first light emitting step or the second light emitting step to travel back as a reflected light; and
an arithmetic step for calculating size information of the object based on a synthesized range image obtained by synthesizing a range image obtained during light emission in the first light emitting step and a range image obtained during light emission in the second light emitting step.
